(19) United States
(12) Patent Application Publication
(10) Pub. No.: US 2008/0118732 A1
(43) Pub. Date: May 22, 2008

(54) PACKING LAMINATE

(75) Inventors: SHAO-HUI ZHANG, Shenzhen (CN); JIAN-BIN DENG, Shenzhen (CN); QING-MING YUAN, Shenzhen (CN); BO LIU, Shenzhen (CN); YI ZHAO, Shenzhen (CN); JI-YI HU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRIAL CO,.LTD., Shenzhen (CN); SUTECH TRADING LIMITED, Tortola (VG)

(21) Appl. No.: 11/733,171

(22) Filed: Apr. 9, 2007

(30) Foreign Application Priority Data
Nov. 17, 2006 (CN) 200610156900.0

(51) Int. Cl. B32B 27/32; B32B 27/40; B32B 27/08

(52) U.S. Cl. 428/220; 428/423.1; 428/523; 428/516

(57) ABSTRACT

A packing laminate (100) includes a main layer (10) and a resin film (20). The main layer is advantageously made of polystyrene. The resin film is usefully made of polyethylene. The resin film is formed on a surface of the main layer. Due to the excellent durability of the polyethylene, the packing laminate, overall, has excellent surface wear characteristics and impact resistance, and such a layer of polyethylene can prevent particles in the main layer from otherwise being scraped/abraded off therefrom.

### BACKGROUND OF THE INVENTION

1. Field of the Invention

The present invention relates to packing laminates and, particularly, to a polystyrene packing laminate.

2. Description of Related Art

Polystyrene is a clear resin and is easily molded to various products, such as packing laminates. In order to improve impact resistance of polystyrene packing laminates, a flexible powder, such as rubber and flexible resin powder, has been added to at least some such packing laminates. Additionally, an organic or inorganic colored powder is also generally added into the polystyrene packing laminates for improving appearance thereof. However, the current polystyrene packing laminates are poor in durability, and the flexible powder or colored powder can, often rather easily, be scraped/abraded off the polystyrene packing laminates during handling, transportation, or rubbing against other articles. The flexible powder or the colored powder that is scraped off may contaminate the articles packed by the polystyrene packing laminates. As the articles may be electronic devices, the particles may enter onto their circuit boards, which could result in failure and/or reduced performance of the electronic devices.

Therefore, a durable packing laminate is desired in order to overcome the above-described shortcomings.

### SUMMARY OF THE INVENTION

In one embodiment thereof, a packing laminate is provided. The packing laminate includes a main layer and a resin film. The main layer is made of polystyrene. The resin film is made of polyethylene. The resin film is formed on a surface of the main layer.

Other advantages and novel features will become more apparent from the following detailed description of preferred embodiments when taken in conjunction with the accompanying drawings.

### BRIEF DESCRIPTION OF THE DRAWINGS

Many aspects of the packing laminate can be better understood with reference to the following drawing. The components in the drawing are not necessarily drawn to scale, the emphasis instead being placed upon clearly illustrating the principles of the packing laminate. Moreover, in the drawings, like reference numerals designate corresponding parts throughout the several views.

FIG. 1 is a schematic view of a first preferred embodiment of a packing laminate; and

FIG. 2 is a schematic view of a second embodiment of a packing laminate.

### DETAILED DESCRIPTION OF THE INVENTION

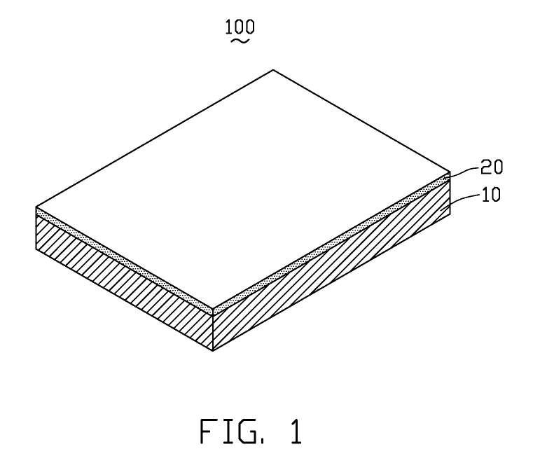

Referring to FIG. 1, in a preferred embodiment, a packing laminate 100 includes a main layer 10 and a resin film 20. The polyethylene layer 20 is formed on (most suitably, directly thereon) an outer surface of the main layer 10.

The main layer 10 is made primarily of polystyrene resin, with other common laminate additives, such as a flexible powder and/or organic or inorganic colored particles, potentially added therein and/or thereon. Given that a non-foamed polystyrene shows an excellent ability to resist impact, especially compared to a foamed polystyrene, the main layer 10 should preferably be made of such a non-foamed polystyrene. Thus, during handling or transportation, the packing laminate 100 can adequately resist being cracked during impact. The colored particles should preferably be an inorganic pigment, for example, titanium dioxide (advantageously, the anatase form thereof). Further, for maximum visible effect, such colored particles should be at (i.e., on) or near a given viewable surface of the main layer 10. Rubber and/or a flexible thermal plastic powder, such as polyurethane, can also be added to the polystyrene resin, in order to improve the flexibility of the packing laminate 100. A thickness of the main layer 10 may be in an approximate range from 0.3 mm to 1.2 mm, and should preferably be 0.8 mm.

The resin film 20 is advantageously made of polyethylene. The polyethylene may be a low-density polyethylene or a high-density polyethylene. Usefully, if an article packed by the packing laminate 100 has a smooth surface, with that smooth surface contacting the packing laminate 100, the resin film 20 should be made of low-density polyethylene. Alternatively, if the article packed by the packing laminate 100 has a rough surface, with that rough surface contacting the packing laminate 100, the resin film 20 should, most suitably, be made of a high-density polyethylene. A thickness of the resin film 20 may, beneficially, be about in a range from 0.05 mm to 0.2 mm, and should preferably be 0.1 mm. When the thickness of the resin film 20 is equal to or greater than 0.05 mm, the packing laminate 100 can display an excellent durability during use. When the thickness of the resin film 20 is less than or equal to 0.2 mm, the resin film 20 can maintain excellent adhesion to the main layer 10.

The resin film 20 may, quite suitably, be thermally bonded to the main layer 10. It should be understood that a process for applying the resin film 20 onto the main layer 10 might instead be carried out via, e.g., immersion, brushing/painting, or co-extrusion.

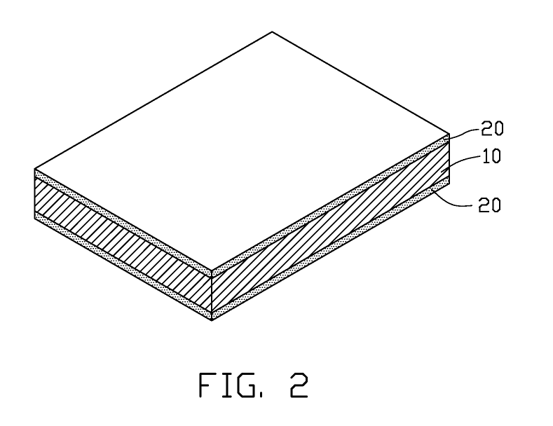

It should be understood that, referring to FIG. 2, in a second preferred embodiment, the main layer 10 might have an inner surface opposite to the outer surface thereof, and the inner surface might also have a resin film 20 applied thereon.

A main advantage of the packing laminate 100 is that, due to the excellent durability of the polyethylene, the packing laminate 100 has excellent surface wear and impact resistance, and the presence of the resin film 20 can prevent additive particles in the main layer 10 from otherwise being scraped/abraded off.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A packing laminate, comprising:
a main layer comprised of polystyrene; and
a resin film comprised of polyethylene, the resin film being formed on a first surface of the main layer.

2. The packing laminate as claimed in claim 1, wherein the main layer has colored particles added at least one of therein and thereon.

3. The packing laminate as claimed in claim 2, wherein the colored particles are comprised of titanium dioxide.

4. The packing laminate as claimed in claim 1, wherein the main layer has a flexible powder added at least one of therein and thereon.

5. The packing laminate as claimed in claim 4, wherein the flexible powder is comprised of at least one of rubber and polyurethane.

6. The packing laminate as claimed in claim 1, wherein a thickness of the main layer is in an approximate range from 0.3 mm to 1.2 mm.

7. The packing laminate as claimed in claim 1, wherein the resin film is comprised of a low-density polyethylene.

8. The packing laminate as claimed in claim 1, wherein the resin film is comprised of a high-density polyethylene.

9. The packing laminate as claimed in claim 1, wherein a thickness of the resin film is in an approximate range from 0.05 mm to 0.2 mm.

10. The packing laminate as claimed in claim 1, wherein the thickness of the resin film is 0.1 mm.

11. The packing laminate as claimed in claim 1, wherein the main layer has a second surface opposite to the first surface, the second surface having a polyethylene film formed thereon.

12. The packing laminate as claimed in claim 1, wherein the resin film is thermally bonded to the main layer.
